(19) United States
(12) Patent Application Publication
(10) Pub. No.: US 2026/0151910 A1
(43) Pub. Date: Jun. 4, 2026

(54) ROBOTIC MOTION CONTROL

(71) Applicant: TENCENT TECHNOLOGY (SHENZHEN) COMPANY LIMITED, Shenzhen (CN)

(72) Inventors: Jingchen LI, Shenzhen (CN); Xiong LI, Shenzhen (CN); Dongsheng ZHANG, Shenzhen (CN); Shuai WANG, Shenzhen (CN); Yufeng ZHANG, Shenzhen (CN); Zhengyou ZHANG, Shenzhen (CN)

(73) Assignee: TENCENT TECHNOLOGY (SHENZHEN) COMPANY LIMITED, Shenzhen (CN)

(21) Appl. No.: 19/459,975

(22) Filed: Jan. 26, 2026

Related U.S. Application Data
(63) Continuation of application No. PCT/CN2024/119671, filed on Sep. 19, 2024.

(30) Foreign Application Priority Data
Oct. 9, 2023 (CN) 202311306495.6

(51) Int. Cl. B25J 9/16; B25J 11/00

(52) U.S. Cl. CPC B25J 9/1666; B25J 11/009

(57) ABSTRACT

In an action processing method, a robot is controlled to move to an action region of an individual on a first support structure. According to a first motion sequence, a manipulator assembly of the robot is controlled to adjust the individual from a supine posture on the first support structure to a lateral recumbent posture on the first support structure. The manipulator assembly includes a first manipulator and a second manipulator. According to a second motion sequence, the manipulator assembly is controlled to adjust the individual from the lateral recumbent posture to an upright seated posture on the first support structure. According to a third motion sequence, the manipulator assembly is controlled to transfer the individual from the upright seated posture on the first support structure to an upright seated posture on a second support structure.

### RELATED APPLICATIONS

The present application is a continuation of International Application No. PCT/CN 2024/119671, filed on Sep. 19, 2024, which claims priority to Chinese Patent Application No. 202311306495.6, filed on Oct. 9, 2023. The entire disclosures of the prior applications are hereby incorporated by reference.

### FIELD OF THE TECHNOLOGY

This application relates to the robot technologies, including an action processing method for a robot.

### BACKGROUND OF THE DISCLOSURE

In related technology, a solution of assisting a target subject (for example, an elderly person or a person with an injured leg) in moving from a bed to a wheel chair is implemented via a dedicated device. A bed with a function of assisting in turnover is designed, a lifting method is used to assist in transferring the target subject, or a walker and an intelligent wheel chair are used to transfer the target subject.

However, the solution provided in the related technology belongs to the dedicated device. The dedicated device has a single function, and usually needs to collaborate with a manual operation in a transfer process. Consequently, the transfer of the target subject cannot be implemented autonomously.

### SUMMARY

Aspects of this disclosure provide an action processing method for a robot, a system, and a non-transitory computer-readable storage medium, to sequentially change, with autonomy, a pose of a target subject based on an action sequence, to finally complete adjustment of the target subject from a first pose to a second pose. Because the final pose is adjusted based on a plurality of actions, convenience and safety of a pose adjustment process can be improved. Examples of technical solutions of this disclosure may be implemented as follows:

An aspect of this disclosure provides an action processing method for a robot. In the method, the robot is controlled to move to an action region of an individual on a first support structure. The action region is a region in which the robot is capable of executing an action to assist the individual. According to a first motion sequence, a manipulator assembly of the robot is controlled to adjust the individual from a supine posture on the first support structure to a lateral recumbent posture on the first support structure. The manipulator assembly includes a first manipulator and a second manipulator. According to a second motion sequence, the manipulator assembly is controlled to adjust the individual from the lateral recumbent posture to an upright seated posture on the first support structure. According to a third motion sequence, the manipulator assembly is controlled to transfer the individual from the upright seated posture on the first support structure to an upright seated posture on a second support structure. The second support structure is different from the first support structure. Each motion in each of the first motion sequence, the second motion sequence, and the third motion sequence causes a corresponding posture change of the individual.

An aspect of this disclosure provides a system. The system includes processing circuitry configured to control a robot to move to an action region of an individual on a first support structure. The action region is a region in which the robot is capable of executing an action to assist the individual. The processing circuitry is configured to control, according to a first motion sequence, a manipulator assembly of the robot to adjust the individual from a supine posture on the first support structure to a lateral recumbent posture on the first support structure. The manipulator assembly includes a first manipulator and a second manipulator. The processing circuitry is configured to control, according to a second motion sequence, the manipulator assembly to adjust the individual from the lateral recumbent posture to an upright seated posture on the first support structure. The processing circuitry is configured to control, according to a third motion sequence, the manipulator assembly to transfer the individual from the upright seated posture on the first support structure to an upright seated posture on a second support structure. The second support structure is different from the first support structure. Each motion in each of the first motion sequence, the second motion sequence, and the third motion sequence causes a corresponding posture change of the individual.

An aspect of this disclosure provides an action processing method for a robot, including: the robot moves to an action scope of a target subject, the target subject being supported by a target object, and the action scope being an area range in which the robot is capable of executing an action for the target subject; autonomously and sequentially executing, through a bionic component of the robot, each action in an action sequence for the target subject supported by the target object, to adjust the target subject from a first pose to a second pose on the target object, each action corresponding to one pose change of the target subject, and a pose change from the first pose to the second pose being obtained based on a plurality of pose changes of the action sequence.

An aspect of this disclosure provides an action processing apparatus for a robot, including: a movement module, configured as that the robot moves to an action scope of a target subject, the target subject being supported by a target object, and the action scope being an area range in which the robot is capable of executing an action for the target subject; and a fourth action module, configured to autonomously and sequentially execute, through a bionic component of the robot, each action in an action sequence for the target subject supported by the target object, to adjust the target subject from a first pose to a second pose on the target object, each action corresponding to one pose change of the target subject, and a pose change from the first pose to the second pose being obtained based on a plurality of pose changes of the action sequence.

An aspect of this disclosure provides an action processing method for a robot, including: autonomously and sequentially executing, through a bionic component of the robot, each action in a first action sequence for a target subject supported by a first target object, to adjust the target subject from lying on the back on the first target object to lying on the side on the first target object; autonomously and sequentially executing, through the bionic component of the robot, each action in a second action sequence for the target subject supported by the first target object, to adjust the target subject from lying on the side on the first target object to sitting up on the first target object; and autonomously and sequentially executing, through the bionic component of the robot, each action in a third action sequence for the target subject supported by the first target object, to adjust the target subject from sitting up on the first target object to sitting up on a second target object, each action corresponding to one pose change of the target subject, and each adjustment for the target subject being obtained based on a plurality of pose changes of a corresponding action sequence.

An aspect of this disclosure provides an action processing apparatus for a robot, including: a first action module, configured to autonomously and sequentially execute, through a bionic component of the robot, each action in a first action sequence for a target subject supported by a first target object, to adjust the target subject from lying on the back on the first target object to lying on the side on the first target object; a second action module, configured to autonomously and sequentially execute, through the bionic component of the robot, each action in a second action sequence for the target subject supported by the first target object, to adjust the target subject from lying on the side on the first target object to sitting up on the first target object; and a third action module, configured to autonomously and sequentially execute, through the bionic component of the robot, each action in a third action sequence for the target subject supported by the first target object, to adjust the target subject from sitting up on the first target object to sitting up on a second target object, each action corresponding to one pose change of the target subject, and each adjustment for the target subject being obtained based on a plurality of pose changes of a corresponding action sequence.

An aspect of this disclosure provides a robot, the robot including a bionic component and a controller, the controller being configured to control the bionic component to perform the action processing methods for a robot provided in the aspects of this disclosure.

An aspect of this disclosure provides an electronic device for controlling a robot, including: a memory, configured to store computer-executable instructions; and a processor, configured to control, when executing the computer-executable instructions stored in the memory, the robot to implement the action processing methods for a robot provided in the aspects of this disclosure.

An aspect of this disclosure provides a non-transitory computer-readable storage medium storing instructions which, when executed by a processor, cause the processor to implement the action processing methods provided for a robot in the aspects of this disclosure.

An aspect of this disclosure provides a computer program product, including computer-executable instructions, the computer-executable instructions, when executed by a processor, implementing the action processing methods provided for a robot in the aspects of this disclosure.

Aspects of this disclosure include the following beneficial effects:
autonomously and sequentially executing, through a bionic component of a robot, each action in a first action sequence for a target subject supported by a first target object, to adjust the target subject from lying on the back on the first target object to lying on the side on the first target object; autonomously and sequentially executing, through the bionic component of the robot, each action in a second action sequence for the target subject supported by the first target object, to adjust the target subject from lying on the side on the first target object to sitting up on the first target object; and autonomously and sequentially executing, through the bionic component of the robot, each action in a third action sequence for the target subject supported by the first target object, to adjust the target subject from sitting up on the first target object to sitting up on a second target object. Because transfer is performed in phases, and a pose change in each phase is implemented based on an action sequence, a pose of a target subject can be safely and stably changed sequentially based on the action sequence, thereby transferring the target subject.

### BRIEF DESCRIPTION OF THE DRAWINGS

FIG. 1A is a schematic diagram of a first structure of an action processing system for a robot according to an aspect of this disclosure.

FIG. 1B is a schematic diagram of a second structure of an action processing system for a robot according to an aspect of this disclosure.

FIG. 2 is a schematic diagram of a structure of an electronic device according to an aspect of this disclosure.

FIG. 3A is a first schematic flowchart of an action processing method for a robot according to an aspect of this disclosure.

FIG. 3B is a second schematic flowchart of an action processing method for a robot according to an aspect of this disclosure.

FIG. 3C is a third schematic flowchart of an action processing method for a robot according to an aspect of this disclosure.

FIG. 3D is a fourth schematic flowchart of an action processing method for a robot according to an aspect of this disclosure.

FIG. 3E is a fifth schematic flowchart of an action processing method for a robot according to an aspect of this disclosure.

FIG. 4 is a schematic diagram of a structure of a robot for an action processing method for a robot according to an aspect of this disclosure.

FIG. 5A is a schematic diagram of a change of a first pose of a first action sequence according to an aspect of this disclosure.

FIG. 5B is a schematic diagram of a change of a second pose of a first action sequence according to an aspect of this disclosure.

FIG. 5C is a schematic diagram of a change of a third pose of a first action sequence according to an aspect of this disclosure.

FIG. 6A is a schematic diagram of a change of a first pose of a second action sequence according to an aspect of this disclosure.

FIG. 6B is a schematic diagram of a change of a second pose of a second action sequence according to an aspect of this disclosure.

FIG. 7A is a schematic diagram of a change of a first pose of a third action sequence according to an aspect of this disclosure.

FIG. 7B is a schematic diagram of a change of a second pose of a third action sequence according to an aspect of this disclosure.

FIG. 7C is a schematic diagram of a change of a third pose of a third action sequence according to an aspect of this disclosure.

FIG. 8 is a schematic diagram of a pose change of a fourth action sequence according to an aspect of this disclosure.

### DETAILED DESCRIPTION

To make the objectives, technical solutions, and advantages of this disclosure clearer, the following describes this disclosure in further detail with reference to the accompanying drawings. The described aspects are not to be considered as a limitation to this disclosure. Other aspects shall fall within the scope of this disclosure. Further, the descriptions of the terms are provided as examples and are not intended to limit the scope of the disclosure.

In the following descriptions, “some aspects” mentioned describes subsets of all possible aspects, but “some aspects” may be the same subset or different subsets of all the possible aspects, and can be combined with each other without conflict.

In the following descriptions, the terms “first”, “second”, and “third” are merely intended to distinguish between similar objects rather than describe specific orders. The terms “first”, “second”, and “third” may, where permitted, be interchangeable in a particular order or sequence, so that aspects of this disclosure described herein may be performed in an order other than that illustrated or described herein.

Unless otherwise defined, meanings of all technical and scientific terms used in this specification are the same as those usually understood by a person skilled in the art to which this disclosure belongs. The terms used in this specification are merely intended to describe the objectives of aspects of this disclosure, and are not intended to limit this disclosure.

Before aspects of this disclosure are described in further detail, descriptions are made on nouns and terms mentioned in aspects of this disclosure, and the nouns and terms mentioned in aspects of this disclosure are applicable to the following explanations.

1) A robot is an intelligent machine that can work semi-autonomously or fully autonomously. The robot can execute a task like a job or a movement through programming and automatic control.

2) A pose describes a position and a posture of a specific subject (for example, coordinates) in a specified coordinate system. For a robot, the pose is usually used to describe a position and a posture of the robot in a spatial coordinate system.

3) A bionic robot is a robot that imitates living things and engages in work with biological features. A bionic component is a component that imitates an animal action or a human action and that is in the bionic robot. For example, the bionic component is a component that imitates a human arm or body.

4) An incapacitated elderly person is an elderly person who is unable to take care of himself or herself or partially unable to take care of himself or herself in daily life due to illness, degradation of a body function, or another reason. In other words, an incapacitated elderly person is an elderly person who loses at least some activities of daily living (ADL).

5) A track is a continuous strip-like structure and usually includes a series of links or blocks of metal or another material, and these links or blocks are connected through hinges to form a closed loop. A main function of the track is to provide traction and support between a driving wheel of machinery and the ground, so that the machinery can smoothly move on various landforms.

The robot provided in aspects of this disclosure is a robot using legs for a movement, and uses an animal as a bionic subject, to imitate a movement form of the animal and copy a movement capability of the animal based on an engineering technology and a scientific research result. The robot has a very strong adaptability to various environments (including structured environments (such as a road, a railway, and a processed even road surface) and non-structured environments (such as a mountain, a swamp, and a rugged and uneven road surface)), can adapt to various changes in landforms and get over a high obstacle, and can reduce load effectively and improve energy utilization efficiency of a system. Robots may be classified into single-legged robots, biped robots, quadruped robots, hexapod robots, eight-legged robots, and the like based on a quantity of feet. A humanoid robot has an ultra-strong movement capability, has better static stability than a biped robot, and moves more easily and flexibly than a hexapod robot and an eight-legged robot. Therefore, the humanoid robot is a common choice for researching the robot. A gait of the humanoid robot refers to a harmonious relationship between four legs of the humanoid robot in time and space to continuously move. The gait of the humanoid robot is from a gait of a quadruped mammal (for example, a puppy), and may include, but is not limited to, the following three simplified forms: walk, trot, and bound.

FIG. 4 is a schematic diagram of a robot shown in an aspect of this disclosure. As shown in FIG. 4, the quadruped humanoid robot is an intelligent device that can approximately imitate an animal. The quadruped humanoid robot has a capability of flexibly walking and moving in complex landforms and environments, and therefore, is widely used in many application scenarios. For example, in an emergency, the humanoid robot may be configured for tasks such as search and rescue, detection, and demolition, and may work in places, for example, mountain areas, deserts, and forests, that are hard for humans to reach. In daily life, the humanoid robot may serve as an intelligent partner, can interact with humans in a household environment, and can also adapt to different household landforms, for example, slopes and steps. The robot has high intelligence and flexibility, and also has very strong adaptability and practicability.

An example robot includes a plurality of components, for example, a head component (as an example), a body component, and a leg component. Still refer to FIG. 4. The robot 400 includes: a head 401, a body 402, an upper limb 403, a waist component 404, and a leg component 405. The waist component 404 is connected to the body 402 by using an axis of a pitch rotation center 4041, the waist component 404 is connected, by using a hip rotation center 4042, to a plurality of legs included in the leg component 405, and the leg component 405 includes an outer leg 4052 and an inner leg 4051. A part that is of each leg in the leg component and that is in contact with a support surface (for example, the ground) is provided with a wheel 4053. This aspect of this disclosure is not limited thereto. In a specific application process, components of the robot may be provided based on a requirement of an actual application scenario. For example, wheels of the leg component are replaced with structures like tracks, support plates, or anti-slip parts.

An example head component may be installed with perception components such as a visual camera and a voice interaction system, to perform environment interaction and human-machine interaction. In some examples, the head component further includes a neck rotation component to perform a pitch movement and a left and right rotation movement that are of a head, to obtain a broader view. This aspect of this disclosure is not limited thereto.

One end of the head component is connected to the body component of the robot. An example body component may accommodate components such as a battery computing system and a control system, to provide energy and computing support for a movement of the robot.

In addition, the example body component includes, but is not limited to, an upper limb component, a waist component, and a hip component. This aspect of this disclosure is not limited thereto.

Left and right ends of the example body component include symmetrical upper limb components. An example upper limb component includes a shoulder joint component, an arm component, and an end effector. The shoulder joint component has six degrees of freedom to implement complex movements such as rotation and lifting of the arm component in various directions. One end of the arm component is connected to the shoulder joint component, and the other end of the arm component is connected to the end effector. In one aspect, a joint between the arm component and the end effector includes a motor, so that the end effector can move along four degrees of freedom. In one aspect, the end effector may be a mechanical hand of any form, and has abundant degrees of freedom to imitate human movements such as grabbing, pushing, and supporting for subjects of various shapes.

The waist component and the hip component are configured to connect the leg component and the body component. A motor configured to cause the body component to perform pitch rotation is installed inside the waist component, so that the robot can imitate an action of bending over of a human. A motor configured to rotate the leg component is installed inside the hip component. A posture of the leg component may be changed by controlling the motor.

The leg component includes four mechanical legs, and the example robot can move based on the four mechanical legs. The four mechanical legs are respectively two inner legs (shown in gray) and two outer legs (shown in white). Each mechanical leg includes a scalable rigid component and a driving wheel. One end of a scalable rigid component of the inner leg is connected to the body component of the robot, for example, connected to a hip, and the other end is connected to a driving wheel. In one aspect, the inner leg and the outer leg are respectively controlled by different motors. Therefore, relative positions of the inner leg and the outer leg may be changed to be more suitable for a living environment. The scalable rigid component can be lengthened and shortened. A leg motor is configured to drive the mechanical legs to walk. When an obstacle is encountered during walking, the scalable rigid component can get over the obstacle through lengthening or shortening. The driving wheel is configured to perform a wheeled movement.

The scalable rigid component includes a main leg section, a scalable leg section, and a scalable driving mechanism. The main leg section is connected to the leg motor. The scalable leg section is in sliding connection with the main leg section, and one end of the scalable leg section far away from the leg motor is connected to the driving wheel component. The scalable driving mechanism is separately connected to the main leg section and the scalable leg section, and the scalable driving mechanism is configured to drive the scalable leg section to slide. When the scalable driving mechanism drives the scalable leg section to slide away from the leg motor, the mechanical legs are lengthened. When the scalable driving mechanism drives the scalable leg section to slide toward and close to the leg motor, the mechanical legs are shortened. A relationship of relative positions of the main leg section and the scalable leg section is not limited in this aspect of this disclosure. In some examples, a side of the main leg section is in sliding connection with a side of the scalable leg section. In some other examples, the main leg section has an accommodating cavity, a part of the scalable leg section is located in the accommodating cavity, and the scalable leg section can be lengthened or shortened relative to the accommodating cavity. A type of the scalable driving mechanism is not limited in this aspect of this disclosure. In some examples, the scalable driving mechanism is a lead-screw nut mechanism, a synchronous belt mechanism, a gear-rack mechanism, a hydraulic-rod mechanism, an electric push-rod mechanism, or the like.

The robot may further be configured with various sensors, for example, an inertial measurement unit (IMU) sensor and a joint angle encoder. The IMU sensor may provide acceleration and posture information of the robot in real time, and the joint angle encoder may provide joint angle information (for example, an angle of a joint angle and an angular velocity feedback value) of each joint of the robot in real time. Under control of the plurality of motors mentioned above, the example robot can have imitated a real human for actions, for example, running, jumping, and climbing stairs.

In a related technology, a solution of assisting a target subject (the following uses an elderly person as an example for description) from a bed to a wheel chair is implemented via a dedicated device. A bed with assisting in turnover is designed, a lifting method is used to assist the elderly person in transfer, or a walker and an intelligent wheel chair are used to transfer the elderly person. However, the solution provided in the related technology belongs to the dedicated device. The dedicated device has a single function, and usually needs a manual operation. Consequently, the elderly person cannot be transferred autonomously. In addition, the transfer for the elderly person in the related technology has problems of poor safety, poor stability, and a poor force-saving capability. Consequently, it is difficult to apply the transfer to a real scenario.

Aspects of this disclosure provide an action processing method for a robot, an action processing apparatus for a robot, an electronic device for controlling a robot, a computer-readable storage medium, and a computer program product, so that a pose of a target subject can be safely and stably changed sequentially based on an action sequence, thereby transferring the target subject.

The following describes example applications of the electronic device mentioned in the action processing method for a robot provided in aspects of this disclosure. The action processing method for a robot provided in aspects of this disclosure may be collaboratively performed by the electronic device and the robot. For example, the electronic device like a terminal device or a server controls the robot to act. For another example, the robot independently makes an action decision, in other words, the robot autonomously makes an action decision. For example, a central processing unit (CPU) of the robot makes the action decision. The electronic device for controlling the robot provided in aspects of this disclosure may be implemented as various types of user terminals such as a notebook computer, a tablet computer, a desktop computer, a set-top box, and a mobile device (for example, a mobile phone, a portable music player, a personal digital assistant, a dedicated messaging device, and a portable gaming device), or may be implemented as a server.

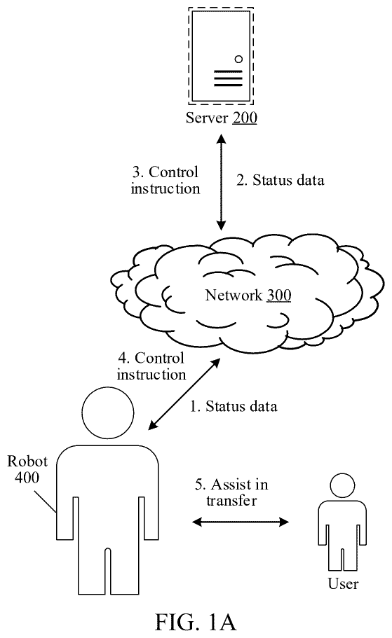

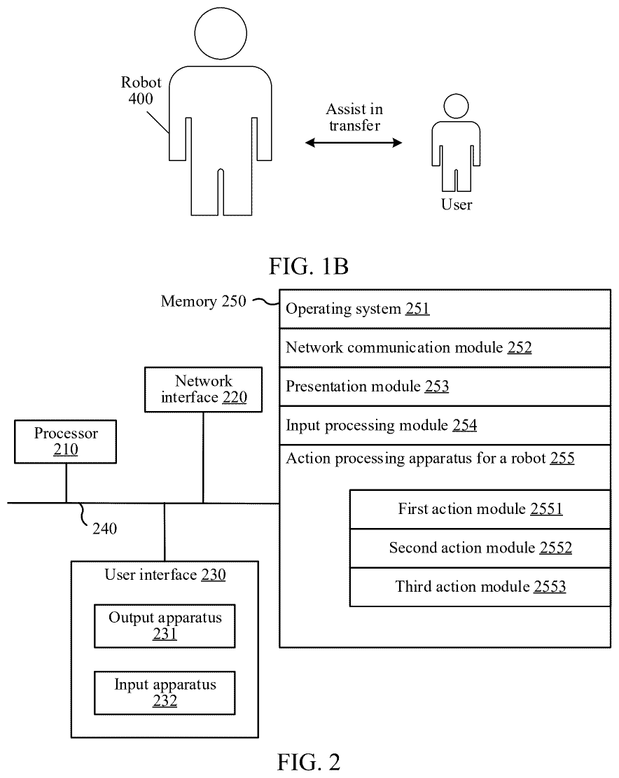

FIG. 1A is a schematic diagram of a first architecture of an action processing system for a robot according to an aspect of this disclosure. A robot 400 is connected to a server 200 over a network 300. The network 300 may be a wide area network, a local area network, or a combination of the wide area network and the local area network.

For example, an electronic device that controls the robot is the server 200, and a user is a person who has difficulty in moving, for example, an elderly person. The robot 400 may be a robot that imitates a human form, and the robot 400 may have a plurality of legs and a plurality of mechanical arms.

When the robot 400 observes a target subject, the robot 400 collects status data of the target subject, and transmits the status data to the server 200. The server 200 performs intent recognition on the target subject, to perceive that the target subject has a requirement of being transferred from a first target object to a second target object. The server 200 transmits action execution instructions of a first action sequence, a second action sequence, and a third action sequence to the robot 400, so that the robot 400 autonomously and sequentially executes each action in the first action sequence for a target subject supported by the first target object, to adjust the target subject from lying on the back on the first target object to lying on the side on the first target object; the robot 400 autonomously and sequentially executes each action in the second action sequence for the target subject supported by the first target object, to adjust the target subject from lying on the side on the first target object to sitting up on the first target object; and the robot 400 autonomously and sequentially executes each action in the third action sequence for the target subject supported by the first target object, to adjust the target subject from sitting up on the first target object to sitting up on the second target object.

In some aspects, the server 200 may be an independent physical server, may be a server cluster including a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. A terminal may be a smartphone, a tablet computer, a notebook computer, a desktop computer, a smart speaker, a smart watch, or the like, but is not limited thereto. The terminal and the server may be directly or indirectly connected in a wired or wireless communication manner. This is not limited in aspects of the present disclosure.

The action processing method for a robot provided in aspects of this disclosure is applied to an artificial intelligence technology. For example, the artificial intelligence (AI) technology may be used to recognize a requirement of a target subject. Artificial intelligence is a theory, method, technology, and application system that use a digital computer or a machine controlled by the digital computer to imitate, extend, and expand human intelligence, perceive an environment, obtain knowledge, and use knowledge to obtain an optimal result. A sensor (for example, a camera, a laser radar, or an ultrasonic sensor) of the robot is used to recognize information about a surrounding environment and a target subject, thereby understanding a dynamic change in the environment, for example, an obstacle or behavior of the target subject. Based on a current status (for example, a pose) of the target subject and current environment information, the artificial intelligence technology is invoked to predict a driving parameter corresponding to an action to be executed by the robot, and then a motor of the robot is controlled based on the driving parameter, so that the robot performs related action processing.

FIG. 1B is a schematic diagram of a second architecture of an action processing system for a robot according to an aspect of this disclosure. A robot 400 is controlled by an internally provided electronic device.

When the robot 400 observes a target subject, the robot 400 collects status data of the target subject, and performs intent recognition on the target subject based on the status data, to perceive that the target subject has a requirement of being transferred from a first target object to a second target object. The electronic device in the robot 400 determines a first action sequence, a second action sequence, and a third action sequence that are to be executed by the robot, and drives a motor of the robot 400, so that the robot 400 autonomously and sequentially executes each action in the first action sequence for a target subject supported by the first target object, to adjust the target subject from lying on the back on the first target object to lying on the side on the first target object; the robot 400 autonomously and sequentially executes each action in the second action sequence for the target subject supported by the first target object, to adjust the target subject from lying on the side on the first target object to sitting up on the first target object; and the robot 400 autonomously and sequentially executes each action in the third action sequence for the target subject supported by the first target object, to adjust the target subject from sitting up on the first target object to sitting up on the second target object.

FIG. 2 is a schematic diagram of a structure of an electronic device according to an aspect of this disclosure. An example in which the electronic device is a server is used as an example for description. The server 200 shown in FIG. 2 includes at least one processor 210 (an example of processing circuitry), a memory 250 (an example of a non-transitory computer-readable storage medium), at least one network interface 220, and a user interface 230. Components in the server 200 are coupled together through a bus system 240. The bus system 240 is configured to implement connection and communication between these components. In addition to a data bus, the bus system 240 further includes a power bus, a control bus, and a state signal bus. However, for ease of clear description, all types of buses are marked as the bus system 240 in FIG. 2.

The processor 210 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The user interface 230 includes one or more output apparatuses 231 that enable presentation of media content, including one or more speakers and/or one or more visual display screens. The user interface 230 further includes one or more input apparatuses 232, including user interface components that help user input, for example, a keyboard, a mouse, a microphone, a touchscreen display screen, a camera, and other input buttons and controls.

The memory 250 may be a removable memory, an irremovable memory, or a combination thereof. Example hardware devices include a solid-state memory, a hard disk drive, an optical disk drive, and the like. In one aspect, the memory 250 includes one or more storage devices physically located away from the processor 210.

The memory 250 includes a volatile memory or a non-volatile memory, or may include both the volatile memory and the non-volatile memory. The non-volatile memory may be a read-only memory (ROM), and the volatile memory may be a random access memory (RAM). The memory 250 described in this aspect of this disclosure is intended to include any suitable type of memory.

In some aspects, the memory 250 can store data to support various operations. Examples of the data include a program, a module, and a data structure, or a subset or a superset thereof. The following descriptions are described as examples.

An operating system 251 includes system programs for processing various basic system services and performing hardware-related tasks, for example, a framework layer, a core library layer, or a driver layer, to implement various basic services and process hardware-based tasks.

A network communication module 252 is configured to arrive at another computer device through one or more (wired or wireless) network interfaces 220. An example network interface 220 includes Bluetooth, Wi-Fi, a universal serial bus (USB), and the like.

A presentation module 253 is configured to enable presentation of information through one or more output apparatuses 231 (for example, a display screen or a speaker) associated with the user interface 230 (for example, a user interface configured to: operate a peripheral device and display content and information).

An input processing module 254 is configured to: detect one or more user inputs or interactions from one or more input apparatuses 232 and translate the detected inputs or interactions.

In some aspects, an action processing apparatus for a robot provided in aspects of this disclosure may be implemented in a software manner. FIG. 2 shows an action processing apparatus 255 for a robot stored in the memory 250. The action processing apparatus 255 for a robot may be software in a form of a program, a plug-in, and the like, and includes the following software modules: a first action module 2551, a second action module 2552, and a third action module 2553. These modules are logical, and therefore may be combined in different manners to form other modules or further split based on an implemented function. Functions of the modules are described below.

An action processing method for a robot provided in aspects of this disclosure is described with reference to an example application and implementation of the robot provided in aspects of this disclosure.

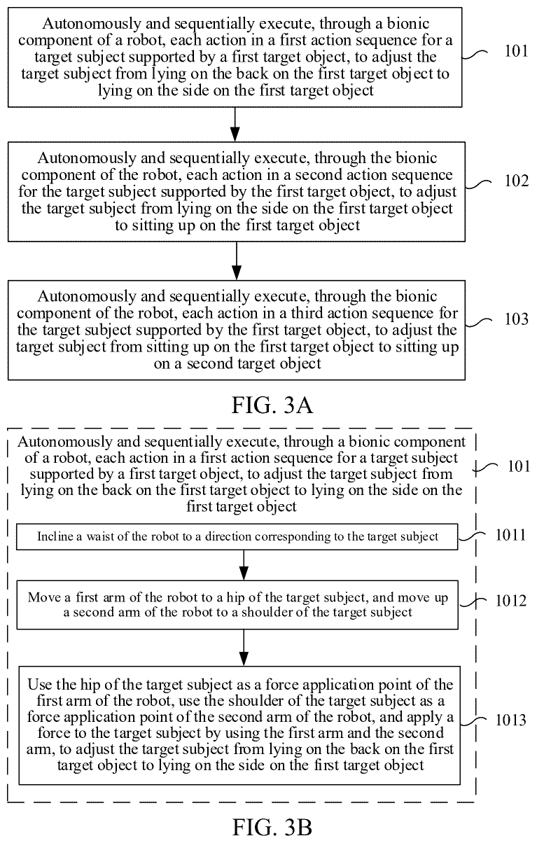

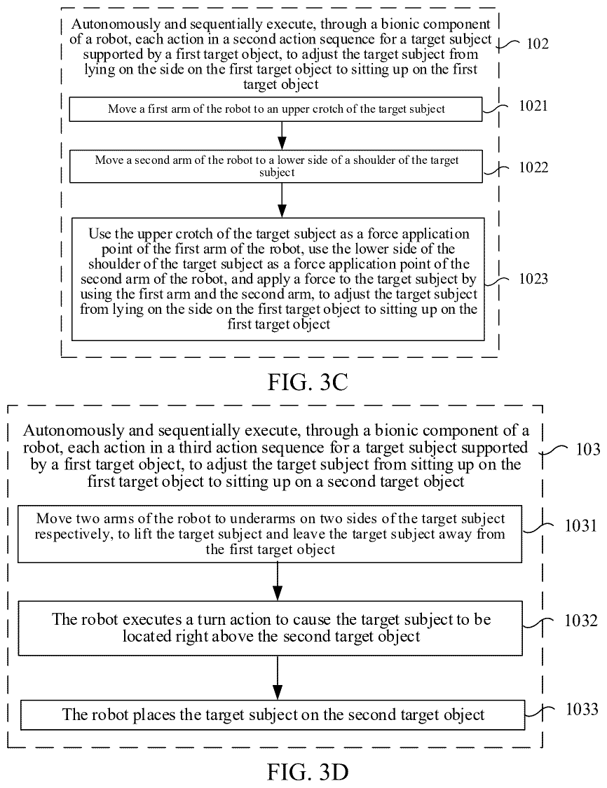

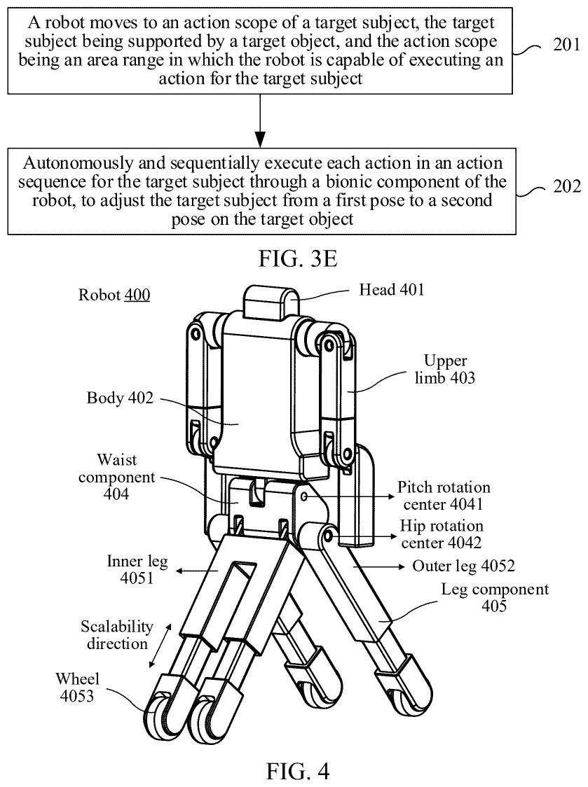

FIG. 3A is a first schematic flowchart of an action processing method for a robot according to an aspect of this disclosure. Descriptions are provided with reference to operation 101 to operation 103 shown in FIG. 3A. In operation 101 to operation 103, an execution body may be an electronic device that controls the robot, or the robot. Alternatively, the robot and an external electronic device may collaborate to perform operation 101 to operation 103. Each action mentioned in this aspect of this disclosure corresponds to one pose change of a target subject, and each adjustment for the target subject is obtained based on a plurality of pose changes of a corresponding action sequence.

Operation 101: Autonomously and sequentially execute, through a bionic component of the robot, each action in a first action sequence for a target subject supported by a first target object, to adjust the target subject from lying on the back on the first target object to lying on the side on the first target object. For example, according to a first motion sequence, a manipulator assembly of the robot is controlled to adjust the individual from a supine posture on the first support structure to a lateral recumbent posture on the first support structure.

In an example, the target subject herein is a user who needs assistance (for example, a person with an injured leg or an elderly person). The following uses the elderly person as an example for description. The bionic component is a component that is provided on the robot and that imitates a human or an animal form. An example of imitating the human is used. The bionic component may be a head, a waist, an arm, or the like of the robot. The bionic component mentioned in operation 101 is a bionic component related to the first action sequence, namely, a bionic component that needs to be used to execute an action in the first action sequence. The first target object herein is an object on which the target subject lies flat, for example, a bed. The following uses the bed as an example for description. The first action sequence is configured for assisting the elderly person in being adjusted from lying on the back to lying on the side on the bed. An initial pose of the elderly person is lying flat on the bed. A plurality of actions in the first action sequence are executed, so that the elderly person is adjusted from a pose of lying flat on the bed to a pose of lying on the side on the bed.

For ease of understanding, a structure of the robot mentioned in the action processing method for a robot provided in this aspect of this disclosure is explained and described. The bionic component of the robot includes leg components, a body, and mechanical arms, the mechanical arms include a first arm and a second arm, the leg components include an inner leg and an outer leg. The mechanical arms are configured to adjust a posture of the target subject. One end that is of the leg component and that is in contact with a contact surface is provided as any one of the following components: a track, a wheel, and a sucker. The mechanical arms of the robot may be configured to: adjust the posture of the target subject and move the target subject. The leg components of the robot can provide support for the robot, maintain balance of the robot, and prevent the robot from falling down during moving. The body of the robot is configured to connect the mechanical arms and the leg components of the robot.

FIG. 3B is a second schematic flowchart of an action processing method for a robot according to an aspect of this disclosure. Autonomously and sequentially executing, through the bionic component of the robot, each action in the first action sequence for the target subject supported by the first target object, to adjust the target subject from lying on the back on the first target object to lying on the side on the first target object in operation 101 may be implemented by using operation 1011 to operation 1013 shown in FIG. 3B.

Operation 1011: Incline a waist of the robot to a direction corresponding to a target subject, to cause the target subject to be in an action scope of the robot. For example, a body portion of the robot is inclined toward the individual to position the individual within the action region.

In an example, the waist of the robot is inclined to the elderly person. To ensure stability, it needs to be ensured herein that an inclination angle is less than a first inclination angle threshold. The first inclination angle threshold is a maximum inclination angle that keeps an action stable and that is obtained through experimental tests. If the inclination angle is greater than the first inclination angle threshold, there is a high probability of overturning.

Operation 1012: Move a first arm of the robot to a hip of the target subject, and move up a second arm of the robot to a shoulder of the target subject. For example, the first manipulator of the robot is moved toward a hip region of the individual.

In an example, if the first arm is a left arm, the second arm is a right arm; or if the first arm is a right arm, the second arm is a left arm. Because a force-saving requirement needs to be considered, two hands of the robot collaboratively apply a force, so that a force of a single hand can be reduced. A distance between application points of the two hands is as long as possible to save a force. Considering a body structure of the elderly person, it is more appropriate to apply forces on the shoulder and the hip. Force application of the robot is driven by a motor in a structure of the robot, thereby saving an applied force of the robot. This can save electric energy consumed by the robot. The force-saving requirement is saving electric energy resources consumed by the robot.

Operation 1013: Use the hip of the target subject as a force application point of the first arm of the robot, use the shoulder of the target subject as a force application point of the second arm of the robot, and apply a force to the target subject by using the first arm and the second arm, to adjust the target subject from lying on the back on the first target object to lying on the side on the first target object. For example, the second manipulator is moved toward a shoulder region of the individual. The first manipulator and the second manipulator are controlled to apply force respectively at the hip region and the shoulder region to adjust the individual from the supine posture to the lateral recumbent posture on the first support structure.

In some aspects, applying the force to the target subject by using the first arm and the second arm, to adjust the target subject from lying on the back on the first target object to lying on the side on the first target object in operation 1013 may be implemented by using the following technical solution: applying, to the target subject by using the first arm and the second arm, an action force facing away from the robot, to adjust the target subject from lying on the back to lying on the side facing away from the robot; or applying, to the target subject by using the first arm and the second arm, an action force facing the robot, to adjust the target subject from lying on the back to lying on the side facing the robot.

Herein, there may be two types of implementations. The target subject may be turned away from the robot, or the target subject may be turned toward the robot. This is because there are two sides of an elderly person lying on the back: a left side corresponding to a left arm and a right side corresponding to a right arm. When the second target object is located on the left side corresponding to the left arm of the elderly person, the target subject is turned toward the left side; or when the second target object is located on the right side corresponding to the right arm of the elderly person, the target subject is turned toward the right side. When lying on the side is approached in a later action stage, the two hands need to collaborate to provide an opposite force to maintain stability of the elderly person (a small force downward and forward is provided relative to the robot, and a direction and a value of the force herein are obtained based on imitation tests). After the elderly person is stable, the hands are released.

In some aspects, before the waist of the robot is inclined to the direction corresponding to the target subject, to cause the target subject to be in the action scope of the robot, the robot removes an obstacle object in an area of the target subject; the robot straightens front legs of the robot below the first target object to form a support structure; the robot places two arms of the target subject in front of a chest of the target subject; and the robot adjusts two legs of the target subject from a straightened state to a bent state. The bent state, the support structure, and the placement of the two arms are configured for keeping the target subject stable in a process of adjusting the target subject from lying on the back on the first target object to lying on the side on the first target object.

In an example, stability needs to be considered in an action design, and the two legs of the elderly person need to be kept in a bent state. If the two legs of the elderly person are not kept in the bent state, the elderly person is unstable after lying on the side. Therefore, when the elderly person is in a state of lying on the back, the elderly person is first assisted in bending the legs. To keep stable, the robot is required to resist a risk of forward overturning. Therefore, a chassis of the robot expands as much as possible and extends under a bed, and is as close to the bed as possible, and an edge of the bed may be abutted against when necessary, to avoid overturning. Spatial interference also needs to be considered in the action design, to prevent the elderly person from pressing hands during shifting from lying on the back to lying on the side. The elderly person is assisted in placing the hands in front of the chest at the beginning (in the state of lying on the back). Front legs of the robot extend under the bed to improve a support surface and improve stability. Hospital beds or beds for elderly care all have bottom space.

Operation 102: Autonomously and sequentially execute, through the bionic component of the robot, each action in a second action sequence for the target subject supported by the first target object, to adjust the target subject from lying on the side on the first target object to sitting up on the first target object. For example, according to a second motion sequence, the manipulator assembly is controlled to adjust the individual from the lateral recumbent posture to an upright seated posture on the first support structure.

In an example, the second action sequence is configured for assisting the elderly person from lying on the side to sitting up, and the two legs of the elderly person are put down to a bed edge. The robot uses a left hand to support an upper crotch of the elderly person, and uses a right hand to support a lower part of a shoulder of a lower side of the elderly person. The left hand applies a force to the left and downward, and the right hand applies a force to the left and upward, so that the elderly person is shifted from a state of lying on the side to a state of sitting up.

In some aspects, FIG. 3C is a third schematic flowchart of an action processing method for a robot according to an aspect of this disclosure. Autonomously and sequentially executing, through the bionic component of the robot, each action in the second action sequence for the target subject supported by the first target object, to adjust the target subject from lying on the side on the first target object to sitting up on the first target object in operation 102 may be implemented by using operation 1021 to operation 1023 shown in FIG. 3C.

Operation 1021: Move a first arm of the robot to an upper crotch of a target subject. For example, the first manipulator of the robot is moved toward an upper hip region of the individual.

In an example, when the elderly person is in a state of lying on the side, a left arm or a right arm of the robot is moved to the upper crotch, that is, a hip part away from a bed.

Operation 1022: Move a second arm of the robot to a lower side of a shoulder of the target subject. For example, the second manipulator of the robot is moved toward a lower side of a shoulder of the individual.

In an example, when the elderly person is in a state of lying on the side, a left arm or a right arm of the robot is moved to the lower side of the shoulder, that is, a shoulder part by a bed. The second arm herein is an arm different from the first arm. If the first arm is the left arm, the second arm is the right arm; or if the first arm is the right arm, the second arm is the left arm.

Operation 1023: Use the upper crotch of the target subject as a force application point of the first arm of the robot, use the lower side of the shoulder of the target subject as a force application point of the second arm of the robot, and apply a force to the target subject by using the first arm and the second arm, to adjust the target subject from lying on the side on a first target object to sitting up on the first target object. For example, through the first manipulator and the second manipulator, force is applied respectively at the upper hip region and the lower side of the shoulder to adjust the individual from the lateral recumbent posture to the upright seated posture on the first support structure.

In some aspects, applying the force to the target subject by using the first arm and the second arm in operation 1023 may be implemented by using the following technical solution: applying, to the upper crotch of the target subject by using the first arm, an action force that is parallel to a plane of two legs of the target subject and that is perpendicular to the two legs of the target subject; and applying, to the lower side of the shoulder of the target subject by using the second arm, an action force that is parallel to a body plane of the target subject and that is perpendicular to an upper limb of the arm of the target subject.

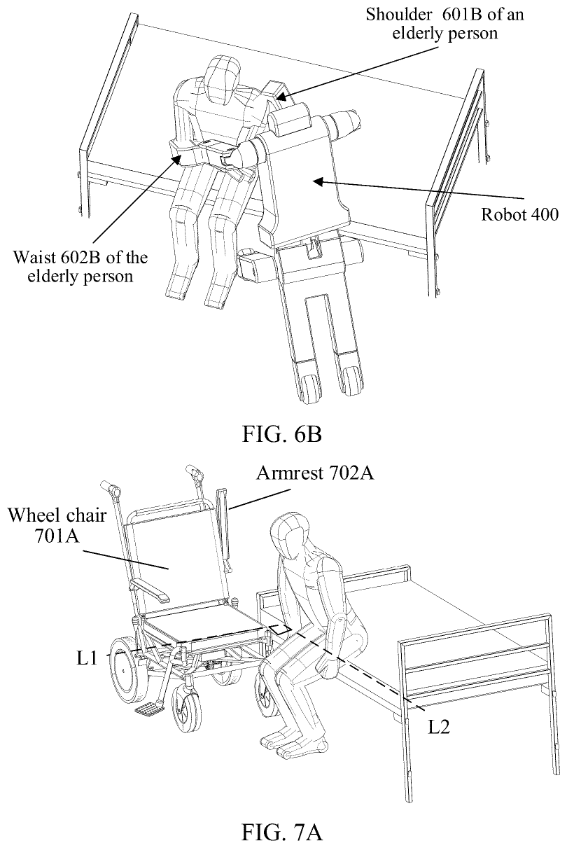

In an example, FIG. 6A and FIG. 6B are schematic diagrams of pose changes of a second action sequence according to aspects of this disclosure. A core action is as follows. A robot uses a left hand to support an upper crotch of an elderly person, and uses a right hand to support a lower side of a shoulder of the elderly person. Two arms and a waist jointly apply a force to change the elderly person from a state of lying on the side to a state of sitting up. Before an action is completed, care needs to be taken to ensure stability of the elderly person and avoid falling down. In a pose adjustment process, the robot accordingly puts two legs of the elderly person under a bed, to keep the legs of the elderly person stable.

In an example, the action force that is parallel to the body plane of the target subject and that is perpendicular to the upper limb of the arm of the target subject is applied to the lower side of the shoulder of the target subject by using the second arm. The action force herein is parallel to the body plane of the target subject and is perpendicular to the upper limb of the arm of the target subject. The elderly person is lifted, by using the action force herein, from the state of lying on the side to a sitting posture. The action force that is parallel to the plane of the two legs of the target subject and that is perpendicular to the two legs of the target subject is applied to the upper crotch of the target subject by using the first arm. The action force herein is parallel to the plane of the two legs and is perpendicular to the two legs, so that it can keep the elderly person stable. Therefore, the action force herein actually plays a stability role. The two action forces herein are simultaneously applied, to support the elderly person and keep the elderly person stable.

Operation 103: Autonomously and sequentially execute, through a bionic component of the robot, each action in a third action sequence for the target subject supported by a first target object, to adjust the target subject from sitting up on the first target object to sitting up on a second target object. For example, according to a third motion sequence, the manipulator assembly is controlled to transfer the individual from the upright seated posture on the first support structure to an upright seated posture on a second support structure.

In an example, the third action sequence is configured for assisting the elderly person from the bed to a wheel chair. The robot uses the two arms to support underarms on two sides of the elderly person to lift the elderly person. The robot turns in place and puts the elderly person in the wheel chair.

In some aspects, before each action in the third action sequence for the target subject supported by the first target object is autonomously and sequentially executed through the bionic component of the robot, to adjust the target subject from sitting up on the first target object to sitting up on the second target object, the following processing is performed when the target subject is not located at an edge of the first target object: lifting a body on any side of the target subject through the bionic component of the robot, and moving the body on the any side of the target subject to the edge of the first target object, to place the target subject on the first target object; and lifting a body on the other side of the target subject through the bionic component of the robot, and moving the body on the other side of the target subject to the edge of the first target object, to place the target subject on the first target object.

In an example, herein, a fourth action sequence needs to be performed before the third action sequence is performed. The fourth action sequence is configured for assisting the elderly person in getting further close to a bed edge in the state of sitting up, to facilitate position transfer. The robot uses the left hand to support a right hip of the elderly person, and uses the right hand to support a left underarm of the elderly person while applying an upward force to lift a left half body of the elderly person, moves toward the front of the elderly person by a short distance, and then puts down the elderly person. Then, a right side is switched to execute a mirroring action, which is repeated a plurality of times.

In some aspects, the target subject and the robot face each other. Lifting the body on the any side of the target subject through the bionic component of the robot may be implemented by using the following technical solution: moving the first arm of the robot under a hip on the any side of the target subject, the first arm and the any side belonging to opposite sides, and moving a left arm of the robot to a right underarm of the elderly person or moving a right arm of the robot to a left underarm of the elderly person because the robot and the target subject face each other; moving the second arm of the robot to an underarm on the other side of the target subject; and applying an upward action force to the target subject by using the two arms and the waist of the robot, to lift the body on the any side of the target subject.

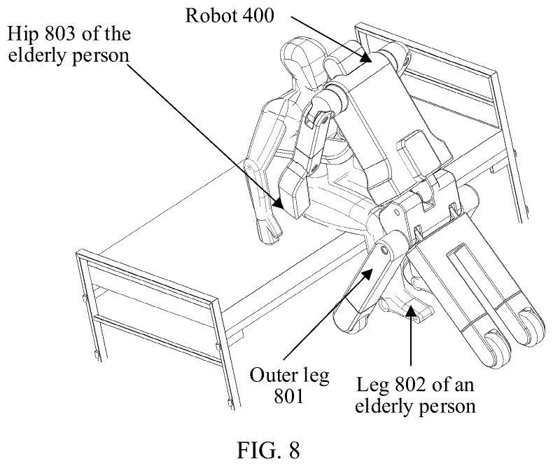

In an example, refer to FIG. 8. A robot uses a left hand to support a lower left hip of an elderly person, and uses a right hand to support a left underarm of the elderly person. Two arms and a waist jointly apply a force to lift a body on a left side of the elderly person, and the robot moves toward the front of the elderly person and toward the rear of the robot and then puts down the elderly person. Then, a mirroring action is executed. The robot uses the left hand to support a right underarm of the elderly person, and uses the right hand to support the right underarm of the elderly person. The two arms and the waist jointly apply a force to lift a body on a right side of the elderly person, and the robot moves toward the front of the elderly person and toward the rear of the robot and then puts down the elderly person. The foregoing action is repeated until the elderly person sits at a position of an edge of a bed, to facilitate a next action.

In some aspects, FIG. 3D is a four schematic flowchart of an action processing method for a robot according to an aspect of this disclosure. Autonomously and sequentially executing, through the bionic component of the robot, each action in the third action sequence for the target subject supported by the first target object, to adjust the target subject from sitting up on the first target object to sitting up on the second target object in operation 103 may be implemented by using operation 1031 to operation 1033 shown in FIG. 3D.

Operation 1031: Move two arms of the robot to underarms on two sides of a target subject respectively, to lift the target subject and leave a first target object. For example, the first manipulator and the second manipulator are controlled respectively to be positioned under axillary regions on opposite sides of the individual to lift the individual off the first support structure.

In an example, force saving needs to considered in an action design. The robot is as close to an elderly person as possible to reduce a force arm. On the premise that the robot can reach the elderly person, forward leaning at a waist is reduced as much as possible. Two hands of the robot collaboratively apply a force, so that a force of a single hand can be reduced. A distance between application points of the two hands is as long as possible. Considering a body structure of a human, two arms of the robot are extended to underarms of the elderly person as much as possible, so that the elderly person approaches a body of the robot. A front part of an upper arm of a mechanical arm is used to apply a force. A force arm is small, and load on the robot is low.

Operation 1032: The robot executes a turn action to cause the target subject to be located right above the second target object. For example, the robot is controlled to move, while maintaining support of the individual, to align the individual above the second support structure.

In an example, the robot only needs to slightly lift the elderly person (a lifting distance is less than a first distance threshold, the first distance threshold herein being a maximum distance that is obtained through experiments and that causes the elderly person to leave support of a bed and reserves support of the ground for legs of the elderly person), and then turns to a wheel chair to obtain support of the wheel chair. An entire action process is short, and load on the robot is low.

Operation 1033: The robot places the target subject on the second target object. For example, the manipulator assembly is controlled to lower the individual onto the second support structure.

For example, when it is determined that the target subject is in right above the second target object, mechanical arms of the robot move downward to lower a weight of the target subject, so that the target subject is placed on the second target object. In other words, the mechanical arms of the robot move downward, so that a hip position of the elderly person descends until the hip position is supported by the wheel chair, to implement an operation of placing the elderly person in the wheel chair.

In an example, the third action sequence is configured for assisting the elderly person in moving from the bed to the wheel chair. Stability needs to be considered in the action design. An initial state and an end state of the elderly person are both stable (a sitting posture). The robot applies a small inward force to the elderly person and a force of hugging tight the robot. The robot is to be as close to the elderly person as possible to resist a risk of forward overturning. Spatial interference needs to be considered in the action design, to avoid interference between two legs of the elderly person and legs of the robot. Outer legs of the robot are wide. Therefore, while the outer legs are in the front and are as close and forward to the elderly person as possible, the legs of the elderly person are placed in the middle of the two legs of the robot. In this case, a projection position of a weight of the body of the elderly person on the ground is in a support area of the robot, and a risk of overturning is low. The support area of the robot is an area formed by parts or structures that are in a structure of the robot and that are configured to fix, stabilize, and support the body of the robot. A wheel-footed robot in this aspect of this disclosure is used as an example for description. A landing position of each wheel of the robot serves as an endpoint, and a formed polygonal area is the support area of the robot.

In some aspects, before operation 1031 is performed, the two arms of the robot move the second target object next to the first target object, and a right angle is formed between the second target object and the first target object; and the robot performs stabilization processing on the second target object, to cause the second target object to be in a stable state.

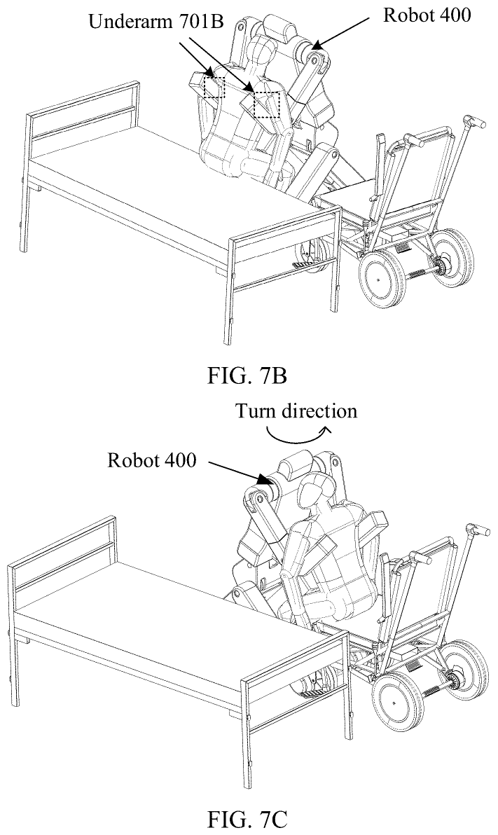

For example, assuming that the second target object is a chair, and the first target object is a bed, that the right angle is formed between the second target object and the first target object means that a right angle is formed between a seat edge of the chair and a side edge of the bed. The seat edge of the chair is an edge that is parallel to a back of the chair. Refer to FIG. 7A. A right angle is formed between a seat edge L1 of a chair and a side edge L2 of a bed.

An example in which the second target object is a wheel chair is used. The wheel chair is provided with wheels. In this case, the wheel chair may be displaced due to an external collision, causing the wheel chair to be unstable. Stabilization processing on the second target object is processing in which a position of the second target object on a support surface is kept unchanged by moving the second target object or adjusting a tightening part of the second target object. For example, a wheel part of the wheel chair is provided with a tightening part (for example, a brake). When the tightening part is in a lock state, the wheel cannot rotate, and the wheel chair is in a stable state. For the wheel chair, the stabilization processing may be processing in which a robot adjusts the tightening part of the wheel of the wheel chair to being in the lock state.

In this aspect of this disclosure, stabilization processing is performed on the second target object, so that a placement failure can be avoided due to an additional movement of the second target object during moving a target subject to the second target object. This can improve a success rate of moving the target subject and safety of the target subject.

In some aspects, before operation 1031, the robot removes an obstacle object in an area of the second target object; front legs of the robot are moved to two sides of the two legs of the target subject, to form an activity scope of the two legs of the target subject; and the robot places two arms of the target subject at two sides of a body of the target subject, and the two arms of the target subject are in a drooping state. The drooping state and the activity scope are configured for keeping the target subject stable in a process of lifting the target subject and leaving the target subject away from the first target object.

For example, for ease of understanding, still refer to FIG. 8. A left side is used as an example in FIG. 8. Outer legs 801 of the robot are in front. The robot is as close to the elderly person as possible, and leaves a sufficient activity scope for legs 802 of the elderly person.

In an example, stability needs to be considered in an action design. Before the target subject is moved from the first target object to the second target object, the obstacle object around the second target object is cleared, so that a collision between the obstacle object and the robot or the target subject can be avoided during moving, thereby improving stability and safety during moving. The target subject is assisted in placing the two arms in the drooping state at the two sides of the body, thereby facilitating stability of force application when the robot places mechanical arms under underarms of the target subject, and reducing a risk that the robot overturns forward. The front legs of the robot move to the two sides of the two legs of the target subject, so that the two legs of the target subject have the activity scope, to avoid the legs of the robot squeezing the legs of the target subject during moving the target subject. This can improve safety and comfort of the target subject during moving the target subject by the robot.

In some aspects, FIG. 3E is a fifth schematic flowchart of an action processing method for a robot according to an aspect of this disclosure. Descriptions are provided with reference to operation 201 and operation 202 shown in FIG. 3E. Each action mentioned in this aspect of this disclosure corresponds to one pose change of a target subject, and a pose change from a first pose to a second pose is obtained based on a plurality of pose changes of an action sequence.

Operation 201: The robot moves to an action scope of the target subject, the target subject being supported by a target object, and the action scope being an area range in which the robot is capable of executing an action for the target subject.

Operation 202: Autonomously and sequentially execute, through a bionic component of the robot, each action in the action sequence for the target subject, to adjust the target subject from the first pose to the second pose on the target object.

The action sequence herein may be a first action sequence, a second action sequence, a third action sequence, and a fourth action sequence. When the action sequence is the first action sequence, the first pose is that the target subject lies on the back on a first target object, and the second pose is that the target subject lies on the side on the first target object; and the second action sequence may be performed after the first action sequence is performed. When the action sequence is the second action sequence, the first pose is that the target subject lies on the side on a first target object, and the second pose is that the target subject sits up on the first target object; and the fourth action sequence may be performed after the first action sequence is performed. When the action sequence is the fourth action sequence, the first pose is that the target subject sits up on a first target object, and the second pose is that the target subject sits up at an edge of the first target object; and the third action sequence may be performed after the fourth action sequence is performed. When the action sequence is the third action sequence, the first pose is that the target subject sits up at an edge of a first target object, and the second pose is that the target subject sits up on a second target object.

Each action in the action sequence for the target subject supported by the target object is autonomously and sequentially executed through the bionic component of the robot, to adjust the target subject from the first pose to the second pose on the target object. Each action corresponds to one pose change of the target subject, and a pose change from the first pose to the second pose is obtained based on the plurality of pose changes of the corresponding action sequence. According to this disclosure, a pose of the target subject based on the action sequence is sequentially changed with autonomy, to finally complete adjustment of the target subject from the first pose to the second pose. Because the final pose is adjusted based on a plurality of actions, convenience and safety of a pose adjustment process can be improved.

The following describes an example application of this aspect of this disclosure in an actual application scenario.

When a robot observes an incapacitated elderly person, the robot collects status data of the incapacitated elderly person, and transmits the status data to a server 200. The server 200 performs intent recognition on the incapacitated elderly person, to perceive that the incapacitated elderly person has a requirement of transferring from a bed to a wheel chair. The server 200 transmits action execution instructions of a first action sequence, a second action sequence, and a third action sequence to the robot, so that the robot autonomously and sequentially executes each action in the first action sequence for the incapacitated elderly person supported by the bed, to adjust the incapacitated elderly person from lying on the back on the bed to lying on the side on the bed; the robot autonomously and sequentially executes each action in the second action sequence for the incapacitated elderly person supported by the bed, to adjust the incapacitated elderly person from lying on the side on the bed to sitting up on the bed; and the robot autonomously and sequentially executes each action in the third action sequence for the incapacitated elderly person supported by the bed, to adjust the incapacitated elderly person from sitting up on the bed to sitting up in the wheel chair.

A humanoid robot assists, in an elderly-care scenario, an elderly person in an incapacitated state in implementing position transfer from a state of lying on the bed to a state of sitting in the wheel chair. Main action implementation operations include: assisting the elderly person from lying on the back to lying on the side, assisting the elderly person from lying on the side to sitting up, getting further close to a bed edge in a state of sitting up, and going from the bed to the wheel chair. Main action sequences are formulated based on safety, and three principles are considered: avoiding spatial interference, maintaining stability, and saving a force (minimizing load borne by the robot, reducing energy consumption, and ensuring safety). According to principles of the stability and saving the force, a major task is completed by using a series of simple action sequences. Each action is for changing a posture of the elderly person only slightly, to facilitate fully utilizing support functions of the bed, the ground, the wheel chair, and the like. Before and after each action starts and ends, the elderly person is in a stable state without assistance of an external force.

This aspect of this disclosure is applicable to the following two types of elderly persons: 1. an elderly person with a slightly weak body as a whole, for example, an elderly person who can be clinically assisted by only one nursing staff member in position transfer, for example, an elderly person who can stabilize a sitting posture but cannot autonomously implement position transfer; and 2. an elderly person with a slightly weak body on one side and needing slight assistance.

For the foregoing suitable elderly person, only assistance needs to be provided during the position transfer, without a need of bearing the weight of the elderly person. A part of the weight of the elderly person is supported by the elderly person, the ground, the bed, and the like, and has a low requirement on load of the robot. A common service robot can meet the requirement. In addition, also for the foregoing reasons, when assistance is provided, a series of action sequences need to be used, and each action changes a state of the elderly person only to a small extent, to fully utilize support of an environment. In addition, in an action gap, the elderly person can keep stable, and the robot does not need to provide support all the time. On the contrary, if states of elderly persons are changed at once to achieve a goal, it is difficult to depend on the environment, and the robot needs to a most part of the weight of the elderly person. The service robot does not have such a high load capability, and this is not conducive to safety and energy saving.

Before the main action implementation steps, necessary preparation work needs to be performed, including cleaning the environment, preparing the wheel chair, before the elderly person is assisted in the position transfer, properly placing four limbs of the elderly person, to ensure safety during the position transfer, and the like. Four limbs of the incapacitated elderly person are relatively weak. The posture of the elderly person is changed by using the four limbs, which cannot control the posture of the elderly person, and increases a risk of spraining. Therefore, the posture of the elderly person needs to be changed by using a body.

The following describes a first action sequence, configured for assisting an elderly person from lying on the back to lying on the side. The elderly person is initially in a state of lying flat. Legs of the elderly person are first shifted from a straightened state to a state in which knees are bent upward, and two arms of the elderly person are put in front of a chest, thereby avoiding being pressed subsequently. Then, a robot uses a left hand to support a hip of the elderly person, and uses a right hand to support a shoulder of the elderly person. The robot applies a force upward and backward, and shifts the elderly person from a state of lying on the back to a state of lying on the side.

The following describes a second action sequence, configured for assisting an elderly person from lying on the side to sitting up, and two legs of the elderly person are put down to a bed edge. A robot uses a left hand to support an upper crotch of the elderly person, and uses a right hand to support a lower part of a shoulder of a lower side of the elderly person. The left hand applies a force to the left and downward, and the right hand applies a force to the left and upward, so that the elderly person is shifted from a state of lying on the side to a state of sitting up.

The following describes a third action sequence, configured for assisting an elderly person from a bed to a wheel chair. A robot uses two arms to support underarms on two sides of the elderly person to lift the elderly person. The robot turns in place and puts the elderly person in the wheel chair.

The following describes a fourth action sequence, configured for assisting an elderly person in getting further close to a bed edge in a state of sitting up, to facilitate position transfer. The robot uses a left hand to support a right hip of the elderly person, and uses a right hand to support a left underarm of the elderly person while applying an upward force to lift a left half body of the elderly person, moves toward the front of the elderly person by a short distance, and then puts down the elderly person. Then, a right side is switched to execute a mirroring action, which is repeated a plurality of times.

The foregoing action sequences are completed based on the robot, and the robot is required to have flexible two arms (six degrees of freedom and above), palms, a waist, and lower limbs that can ensure stable support and to turn in place. A robot having these features is applicable to an action processing method provided in aspects of this disclosure. The action processing method provided in aspects of this disclosure focuses on basic action designs under a safety principle. During specific robot implementation, robot compliance control, intent recognition for an elderly person, and a complete safety policy for exception processing need to be coordinated, thereby further ensuring safety.

In aspects of this disclosure, a human-like robot is used, includes a waist, mechanical arms, palms, and the like, and can implement a human-like action. All universal robot devices are applicable to the action processing method provided in aspects of this disclosure, without a need of a special design. In addition to assisting an elderly person in position transfer, a robot may also be used for other service functions, for example, delivering an object, pushing a wheel chair, assisting in walking and going up and down stairs, preparing a meal, and opening a door. The robot can autonomously complete a task of assisting the elderly person in the position transfer, without a need of manual intervention or operations.

The following describes a design principle of a first action sequence. The first action sequence is configured for assisting an elderly person from lying on the back to lying on the side. Stability needs to be considered in an action design. An initial state (lying on the back) of the elderly person is stable, and an end state (lying on the side) also needs to be kept stable. Legs of the elderly person need to be in a bent state. If the legs of the elderly person are not in the bent state, the elderly person is unstable after lying on the side. Therefore, when the elderly person is in a state of lying on the back at the beginning, the elderly person is first assisted in bending the legs. When the elderly person is adjusted from lying on the back to lying on the side, a robot needs to apply a force upward and backward to the elderly person, and the robot needs to bend over forward for operation. To keep stable, the robot is required to resist a risk of forward overturning. Therefore, a chassis of the robot expands as much as possible and extends under a bed, and is as close to the bed as possible, and an edge of the bed may be abutted against when necessary, to avoid overturning. When lying on the side is approached in a later action stage, two hands need to collaborate to provide an opposite force to maintain stability of the elderly person (a small force downward and forward is provided relative to the robot). After the elderly person is stable, the hands are released. Force saving needs to considered in the action design. The robot is as close to the elderly person as possible to reduce a force arm. On the premise that the robot can reach the elderly person, forward leaning at a waist is reduced as much as possible. An action is completed through force application at the waist. Two hands of the robot collaboratively apply a force, so that a force of a single hand can be reduced. A distance between application points of the two hands is as long as possible. Considering a body structure of a human, it is more appropriate to apply forces on a shoulder and a hip. Spatial interference also needs to be considered in the action design, to prevent the elderly person from pressing hands during shifting from lying on the back to lying on the side. The elderly person is assisted in placing the hands in front of the chest at the beginning (in the state of lying on the back). Front legs of the robot extend under the bed to improve a support surface and improve stability. Hospital beds or beds for elderly care all have bottom space.

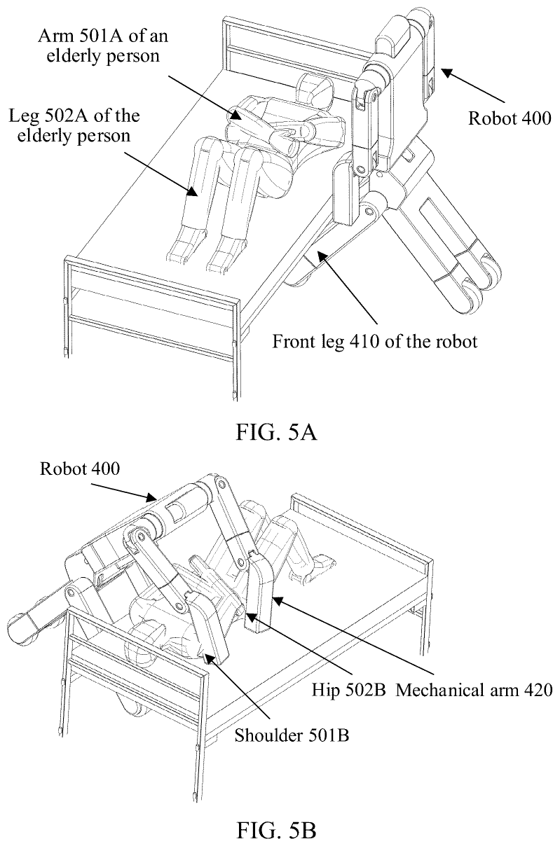

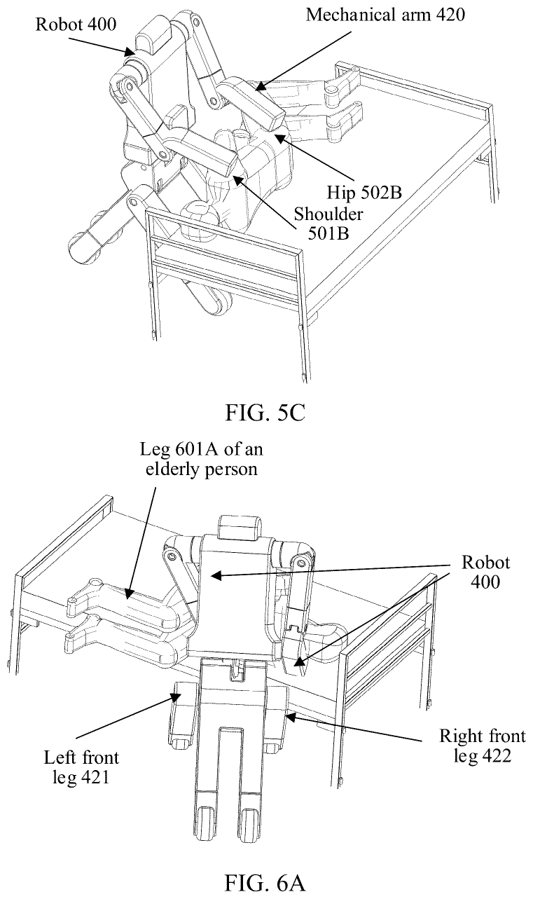

An initial state of the first action sequence is that the elderly person lies on the back on the bed. The robot enters a room, and a preparation action is as follows. The robot cleans working space to avoid clutter on the bed, at a side of the bed, or between the bed and a wheel chair. FIG. 5A is a schematic diagram of a change of a first pose of a first action sequence according to an aspect of this disclosure. A robot 400 moves to a bed edge, and contacts a bed body to stabilize a body of a robot and avoid forward leaning. The robot is as close to the bed (a first target object) as possible, front legs 410 extend under the bed, and the legs are used to abut against the bed. Arms 501A of an elderly person are placed in front of a chest to avoid being pressed, and legs 502A of the elderly person are changed from a straightened state to a bent state. Refer to FIG. 5B and FIG. 5C. FIG. 5B is a schematic diagram of a change of a second pose of a first action sequence according to an aspect of this disclosure, and FIG. 5C is a schematic diagram of a change of a third pose of a first action sequence according to an aspect of this disclosure. A robot 400 leans forward, mechanical arms 420 are lifted, a left hand supports a hip 502B of an elderly person, a right hand supports a shoulder 501B of the elderly person, and two arms and a waist jointly apply a force to change the elderly person from a state of lying flat to a state of lying on the side. In other words, mechanical arms of the robot support shoulders and hips of the elderly person, and the robot applies a force upward and backward (relative to the robot). Before completing an action, the robot ensures stability of the elderly person and avoids falling down in the following manner: The robot adjusts force application by using two hands, and provides a slight force downward and forward (relative to the robot). After a posture of the elderly person is stable, the hands are released. FIG. 5A to FIG. 5C show merely schematic diagrams of actions, and slight adjustment needs to be performed based on specific shapes of arms and palms of the robot during specific implementation.

The following describes a design principle of a second action sequence. The second action sequence is configured for assisting an elderly person from lying on the side to sitting up. Stability needs to be considered in an action design. An initial state (lying on the side) of the elderly person is stable, and an end state (a sitting posture) of the elderly person is also stable. To adjust the elderly person from lying on the side to sitting up, a robot needs to apply a force upward and to the left, and the robot needs to bend over forward (an inclination angle of bending over is less than an inclination angle of bending over in a first action sequence) for operation. To be stable, the robot is required to resist a risk of overturning forward and to the right. In addition, considering that the elderly person is deviated to the left as a whole, the robot faces the elderly person to the left in advance, a chassis expands as much as possible and extends under a bed, and is as close to the bed as possible, and a right leg may abut against an edge of the bed, to avoid overturning forward and to the right. Similarly, in a later action stage, two hands need to collaborate to provide an opposite force to maintain stability of the elderly person (a left hand provides a force to the right, and a right hand provides a force to the left). After the elderly person is stable, the hands are released. Force saving needs to considered in the action design. The robot is as close to the elderly person as possible to reduce a force arm. On the premise that the robot can reach the elderly person, forward leaning at a waist is reduced as much as possible. The two hands of the robot collaboratively apply a force, so that a force of a single hand can be reduced. A distance between application points of the two hands is as long as possible. Considering a body structure of a human, it is more appropriate to apply forces on a shoulder of a lower side (right hand) and an upper hip (left hand). The right hand provides a force upward and to the left, and the left hand provides a force downward and to the left. Spatial interference needs to be considered in the action design, to avoid interference between two legs and the bed when the elderly person sits up. At the beginning, the two legs of the elderly person are moved from the bed to an area outside the edge of the bed and put down. Front legs of the robot extend under the bed to improve a support surface and improve stability. Hospital beds or beds for elderly care all have bottom space. A standing position of the robot needs to be as left as possible but cannot interfere with the legs of the elderly person.

An initial state of the second action sequence is that after the robot completes the first action sequence, the elderly person lies on the side on the bed, and the robot is at a bed edge. Refer to FIG. 6A and FIG. 6B. A preparation action is as follows. Before actions of a second action sequence are executed, two legs of an elderly person are moved outside an edge of the bed. In a process in which an action in FIG. 6A is switched to that in FIG. 6B, for example, in a process in which the elderly person is changed from a state of lying on the side to a state of sitting up, the robot faces the elderly person to the left, as forward as possible, front legs extend under a bed, and front legs (for example, right front legs 422) abut against an edge of the bed, to improve stability. In addition, left front legs 421 of the robot cannot interfere with two legs of the elderly person after sitting up. Still refer to FIG. 6B. A core action is as follows. A left hand of the robot supports an upper crotch of the elderly person, a right hand supports a lower side of a shoulder of the elderly person, and two arms and a waist jointly apply a force (the left hand of the robot presses and holds a hip 602B of the elderly person and applies a force to the left, and the right hand presses and holds a shoulder 601B of the elderly person and applies a force upward and to the left) to change the elderly person from a state of lying on the side to a state of sitting up. Before an action is completed, care needs to be taken to ensure stability of the elderly person and avoid falling down.

The following describes a fourth action sequence, configured for assisting an elderly person in sitting closer to a bed edge, to prepare for a next operation of transferring the elderly person to a wheel chair. Stability needs to be considered in an action design. An initial state and an end state of the elderly person are both stable (a sitting posture). A robot needs to apply an upward force. To keep stable, the robot is required to resist a risk of forward overturning, and the robot is to be as close to the elderly person as possible. Force saving needs to considered in the action design. The robot is as close to the elderly person as possible to reduce a force arm. On the premise that the robot can reach the elderly person, forward leaning at a waist is reduced as much as possible. Two hands of the robot collaboratively apply a force, so that a force of a single hand can be reduced. A distance between application points of the two hands is as long as possible. Only half of a body of the elderly person needs to be lifted, and the body is moved to a bed edge by a very short distance. Therefore, considering a body structure of a person, forces are applied at an underarm and a hip on a same side, and the robot applies a force upward and backward (relative to the robot). Spatial interference needs to be considered in the action design, to avoid interference between two legs of the elderly person and legs of the robot. Refer to FIG. 4. Outer legs of the robot are wide (a distance between two legs included in the outer legs is greater than a distance between two legs included in inner legs). Therefore, while the outer legs are in the front and are as close and forward to the elderly person as possible, legs of the elderly person are in the middle of the two legs of the robot. In this case, a body of the elderly person is basically in a support area of the robot, and a risk of overturning is low.

An initial state of the fourth action sequence is the sitting posture of the elderly person after the second action sequence is completed. Refer to FIG. 8. A robot uses a left hand to support a lower left hip of an elderly person and uses a right hand to support a left underarm of the elderly person. Two arms and a waist jointly apply a force to lift a body on a left side of the elderly person, and the robot moves toward the front of the elderly person and toward the rear of the robot and then puts down the elderly person. Then, a mirroring action is executed. The robot uses the left hand to support a right underarm of the elderly person, and uses the right hand to support the right underarm of the elderly person. The two arms and the waist jointly apply a force to lift a body on a right side of the elderly person, and the robot moves toward the front of the elderly person and toward the rear of the robot and then puts down the elderly person. The foregoing action is repeated until the elderly person sits at a position of an edge of a bed, to facilitate a next action.

The following describes a third action sequence, configured for assisting an elderly person in moving from a bed to a wheel chair. Stability needs to be considered in an action design. An initial state and an end state of the elderly person are both stable (a sitting posture). A robot needs to apply an upward force, and also applies a small inward force to the elderly person and a force of hugging tight the robot to keep the elderly person stable. The robot is to be as close to the elderly person as possible to resist a risk of forward overturning. Force saving needs to considered in the action design. The robot is as close to the elderly person as possible to reduce a force arm. On the premise that the robot can reach the elderly person, forward leaning at a waist is reduced as much as possible. Two hands of the robot collaboratively apply a force, so that a force of a single hand can be reduced. A distance between application points of the two hands is as long as possible. Considering a body structure of a human, two arms of the robot are extended to underarms of the elderly person as much as possible, so that the elderly person approaches a body of the robot. A front part of an upper arm of a mechanical arm is used to apply a force. The force arm is small, and load on the robot is low. In addition, the elderly person only needs to be slightly lifted to leave support of the bed (reserve support of the ground legs of the elderly person), and then turns to a wheel chair to obtain support of the wheel chair. An entire action process is short, and load on the robot is low. Spatial interference needs to be considered in the action design, to avoid interference between the two legs of the elderly person and legs of the robot. Outer legs of the robot are wide. Therefore, while the outer legs are in the front and are as close and forward to the elderly person as possible, the legs of the elderly person are placed in the middle of the two legs of the robot. In this case, the body of the elderly person is basically in a support area of the robot, and a risk of overturning is low.

Refer to FIG. 7A. An initial state of a third action sequence is that after a second action sequence or the third action sequence is completed, the elderly person sits up at a bed edge. Preparation actions are as follows. A wheel chair 701A is moved to the edge of the bed, so that a seat surface edge L1 of the wheel chair and a side surface edge L2 of the bed are at a 90-degree angle; a brake on a wheel of the wheel chair is locked; and an armrest 702A of the wheel chair is lifted. FIG. 7B is a schematic diagram of a change of a second pose of a third action sequence according to an aspect of this disclosure. Core actions of the third action sequence are as follows. Two arms of a robot 400 support underarms 701B on two sides of an elderly person to lift the elderly person; and hips of the elderly person leave an edge of a bed, but legs of the elderly person still touch the ground. In this case, the elderly person is not lifted, and the robot only bears approximately 70% of a weight of the elderly person. FIG. 7B is switched to FIG. 7C. FIG. 7C is a schematic diagram of a change of a third pose of a third action sequence according to an aspect of this disclosure. A robot 400 turns in place, moves an elderly person above a wheel chair, and puts down the elderly person, so that the elderly person sits in the wheel chair. Before an action is completed, care needs to be taken to ensure stability of the elderly person and avoid falling down.

Finally, the elderly person is assisted in approaching a back of the wheel chair, and a corresponding action sequence is similar to a fourth action sequence. Therefore, Details are not described again.

According to an action processing method provided in aspects of this disclosure, a solution (from a bed to a chair) of assisting an incapacitated elderly person in position transfer is implemented by using a robot. In comparison with a dedicated bed, a wheel chair, a dedicated device, or the like, aspects of this disclosure have more personification, and emotional care may be provided. Aspects of this disclosure have universality and are applicable to other robots of a same type. The robot may provide other elderly care and home services in addition to assisting in transfer. The action processing method provided in aspects of this disclosure has autonomy, without a need of a manual operation. This can resolve a problem of a pain point in an elderly care service.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The following continues to describe an example structure of an action processing apparatus 255 for a robot, implemented as software modules, provided in aspects of this disclosure. In some aspects, as shown in FIG. 2, software modules that are in the action processing apparatus 255 for a robot and that are stored in a memory 250 may include: a first action module, configured to autonomously and sequentially execute, through a bionic component of the robot, each action in a first action sequence for a target subject supported by a first target object, to adjust the target subject from lying on the back on the first target object to lying on the side on the first target object; a second action module, configured to autonomously and sequentially execute, through the bionic component of the robot, each action in a second action sequence for the target subject supported by the first target object, to adjust the target subject from lying on the side on the first target object to sitting up on the first target object; and a third action module, configured to autonomously and sequentially execute, through the bionic component of the robot, each action in a third action sequence for the target subject supported by the first target object, to adjust the target subject from sitting up on the first target object to sitting up on a second target object, the second target object being an object different from the first target object, each action corresponding to one pose change of the target subject, and each adjustment for the target subject being obtained based on a plurality of pose changes of a corresponding action sequence.

In some aspects, the first action module is further configured to: incline a waist of the robot to a direction corresponding to the target subject, to cause the target subject to be in an action scope of the robot; move a first arm of the robot to a hip of the target subject, and move up a second arm of the robot to a shoulder of the target subject; and use the hip of the target subject as a force application point of the first arm of the robot, use the shoulder of the target subject as a force application point of the second arm of the robot, and apply a force to the target subject by using the first arm and the second arm, to adjust the target subject from lying on the back on the first target object to lying on the side on the first target object.

In some aspects, the first action module is further configured to: apply, to the target subject by using the first arm and the second arm, an action force facing away from the robot, to adjust the target subject from lying on the back to lying on the side facing away from the robot; or apply, to the target subject by using the first arm and the second arm, an action force facing the robot, to adjust the target subject from lying on the back to lying on the side facing the robot.

In some aspects, the first action module is further configured as: Before a waist of the robot is inclined to a direction corresponding to the target subject, to cause the target subject to be in an action scope of the robot, the robot removes an obstacle object in an area of the target subject; straightening front legs of the robot below the first target object to form a support structure; the robot places two arms of the target subject in front of a chest of the target subject; and the robot adjusts two legs of the target subject from a straightened state to a bent state, the bent state, the support structure, and the placement of the two arms being configured for keeping the target subject stable in a process of adjusting the target subject from lying on the back on the first target object to lying on the side on the first target object.

In some aspects, the second action module is further configured to: move the first arm of the robot to an upper crotch of the target subject; move the second arm of the robot to a lower side of the shoulder of the target subject; and use the upper crotch of the target subject as a force application point of the first arm of the robot, use the lower side of the shoulder of the target subject as a force application point of the second arm of the robot, and apply the force to the target subject by using the first arm and the second arm, to adjust the target subject from lying on the side on the first target object to sitting up on the first target object.

In some aspects, the second action module is further configured to: apply, to the upper crotch of the target subject by using the first arm, an action force that is parallel to a plane of the two legs of the target subject and that is perpendicular to the two legs of the target subject; and apply, to the lower side of the shoulder of the target subject by using the second arm, an action force that is parallel to a body plane of the target subject and that is perpendicular to an upper limb of the arm of the target subject.

In some aspects, the third action module is further configured to: before each action in the third action sequence autonomously and sequentially is executed through the bionic component of the robot for the target subject supported by the first target object, to adjust the target subject from sitting up on the first target object to sitting up on a second target object, perform the following processing when the target subject is not located at an edge of the first target object: lifting a body on any side of the target subject through the bionic component of the robot, and moving the body on the any side of the target subject to the edge of the first target object, to place the target subject on the first target object; and lifting a body on the other side of the target subject through the bionic component of the robot, and moving the body on the other side of the target subject to the edge of the first target object, to place the target subject on the first target object.

In some aspects, the third action module is further configured to: move the first arm of the robot under a hip on the any side of the target subject, the first arm and the any side belonging to opposite sides; move the second arm of the robot to an underarm on the other side of the target subject; and apply an upward action force to the target subject by using the two arms of the robot, to lift the body on the any side of the target subject.

In some aspects, the third action module is further configured to: move the two arms of the robot to underarms on two sides of the target subject respectively, to lift the target subject and leave the target subject away from the first target object; the robot executes a turn action to cause the target subject to be located right above the second target object; and the robot places the target subject on the second target object.

In some aspects, the third action module is further configured as: The two arms of the robot move the second target object next to the first target object, a right angle being formed between the second target object and the first target object; and the robot performs stabilization processing on the second target object, to cause the second target object to be in a stable state.

In some aspects, an action processing apparatus for a robot includes: a movement module, configured as that the robot moves to an action scope of a target subject, the target subject being supported by a target object, and the action scope being an area range in which the robot is capable of executing an action for the target subject; and a fourth action module, configured to autonomously and sequentially execute, through a bionic component of the robot, each action in an action sequence for the target subject supported by the target object, to adjust the target subject from a first pose to a second pose on the target object, each action corresponding to one pose change of the target subject, and a pose change from the first pose to the second pose being obtained based on a plurality of pose changes of the action sequence.

An aspect of this disclosure provides a robot. The robot includes a bionic component and a controller. The controller is configured to control the bionic component to perform the action processing method for a robot in aspects of this disclosure.

An aspect of this disclosure provides an electronic device for controlling a robot, including: a memory, configured to store computer-executable instructions; and a processor, configured to control, when executing the computer-executable instructions stored in the memory, the robot to perform the action processing method for a robot in aspects of this disclosure.

An aspect of this disclosure provides a computer program product. The computer program product includes computer-executable instructions. The computer-executable instruction is stored in a computer-readable storage medium. A processor of an electronic device for controlling a robot reads the computer-executable instructions from the computer-readable storage medium. The processor executes the computer-executable instructions, to cause, to perform the action processing method for a robot in aspects of this disclosure, the electronic device for controlling a robot.

An aspect of this disclosure provides a computer-readable storage medium, such as a non-transitory computer-readable storage medium, storing computer-executable instructions, having the computer-executable instructions stored herein. The computer-executable instructions, when executed by a processor, cause the processor to perform the action processing method for a robot provided in aspects of this disclosure, for example, the action processing method for a robot shown in FIG. 3A to FIG. 3E.

In some aspects, the computer-readable storage medium may be a memory like a ferromagnetic RAM (FRAM), a ROM, a programmable ROM (PROM), an electrically PROM (EPROM), an electrically erasable PROM (EEPROM), a flash memory, a magnetic surface memory, an optical disk, or a compact disc ROM (CD-ROM), or may be any device including one or any combination of the foregoing memories.

In some aspects, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit suitable for use in a computing environment.

In an example, the computer-executable instructions may but do not necessarily correspond to a file in a file system, and may be stored as a part of a file that saves other programs or data, for example, stored in one or more scripts in a hyper text markup language (HTML) document, stored in a single file dedicated to a discussed program, or stored in a plurality of collaborative files (for example, files that store one or more modules, subprograms, or code parts).

In an example, the computer-executable instructions may be deployed to be executed on one electronic device for controlling a robot, executed on a plurality of electronic devices for a robot that are located at one place, or executed on a plurality of electronic devices for controlling a robot that are distributed in a plurality of places and interconnected by a communication network.

In conclusion, each action in an action sequence for a target subject supported by the target object is autonomously and sequentially executed through a bionic component of the robot, to adjust the target subject from a first pose to a second pose on the target object. Each action corresponds to one pose change of the target subject, and a pose change from the first pose to the second pose is obtained based on a plurality of pose changes of a corresponding action sequence. According to this disclosure, a pose of the target subject based on the action sequence is sequentially changed with autonomy, to finally complete adjustment of the target subject from the first pose to the second pose. Because the final pose is adjusted based on a plurality of actions, convenience and safety of a pose adjustment process can be improved.

The foregoing descriptions are merely example aspects of this disclosure, and are not intended to limit the scope of this disclosure. Any modification, equivalent replacement, improvement, and the like made within the spirit and scope of this disclosure shall fall within the scope of this disclosure.

What is claimed is:

1. An action processing method for a robot, the method comprising:
controlling the robot to move to an action region of an individual on a first support structure, the action region being a region in which the robot is capable of executing an action to assist the individual;
controlling, according to a first motion sequence, a manipulator assembly of the robot to adjust the individual from a supine posture on the first support structure to a lateral recumbent posture on the first support structure, the manipulator assembly including a first manipulator and a second manipulator;
controlling, according to a second motion sequence, the manipulator assembly to adjust the individual from the lateral recumbent posture to an upright seated posture on the first support structure; and
controlling, according to a third motion sequence, the manipulator assembly to transfer the individual from the upright seated posture on the first support structure to an upright seated posture on a second support structure, wherein the second support structure is different from the first support structure, and each motion in each of the first motion sequence, the second motion sequence, and the third motion sequence causes a corresponding posture change of the individual.

2. The method according to claim 1, wherein the manipulator assembly is configured to perform biomimetic motions, the first support structure is a bed, and the second support structure is a wheelchair.

3. The method according to claim 1, wherein the first motion sequence comprises:
inclining a body portion of the robot toward the individual to position the individual within the action region;
moving the first manipulator of the robot toward a hip region of the individual;
moving the second manipulator toward a shoulder region of the individual; and
controlling the first manipulator and the second manipulator to apply force respectively at the hip region and the shoulder region to adjust the individual from the supine posture to the lateral recumbent posture on the first support structure.

4. The method according to claim 3, wherein the controlling the first manipulator and the second manipulator to apply the forces comprises:
controlling the first manipulator and the second manipulator, to apply forces that cause one of lateral rotation away from the robot and lateral rotation toward the robot, to turn the individual to the lateral recumbent posture.

5. The method according to claim 3, further comprising:
controlling the robot to remove obstacles from an area surrounding the first support structure;
controlling front legs of the robot to extend under the first support structure to support the robot;
controlling the robot to position arms of the individual across a chest of the individual; and
controlling the robot to bend legs of the individual from a straightened state to a bent state, wherein
the bent state, the extended front legs, and the positioning of the arms of the individual increase stability of the individual during adjustment from the supine posture to the lateral recumbent posture.

6. The method according to claim 3, wherein the second motion sequence comprises:
moving the first manipulator of the robot toward an upper hip region of the individual;
moving the second manipulator of the robot toward a lower side of a shoulder of the individual; and
applying, through the first manipulator and the second manipulator, force respectively at the upper hip region and the lower side of the shoulder to adjust the individual from the lateral recumbent posture to the upright seated posture on the first support structure.

7. The method according to claim 6, wherein the applying the forces comprises:
applying, through the first manipulator, a force in a direction parallel to a plane defined by legs of the individual and perpendicular to a longitudinal axis of the legs; and
applying, through the second manipulator, a force in a direction parallel to a torso plane of the individual and perpendicular to a longitudinal axis of an upper arm of the individual.

8. The method according to claim 1, further comprising:
when the individual is not positioned at an edge of the first support structure, performing a preparatory operation including:
controlling the manipulator assembly to lift a first lateral body segment of the individual;
controlling the robot to move the first lateral body segment of the individual toward the edge of the first support structure;
controlling the manipulator assembly to lift a second lateral body segment of the individual; and
controlling the robot to move the second lateral body segment toward the edge of the first support structure.

9. The method according to claim 8, wherein when the manipulator assembly and the individual face each other, the controlling the manipulator assembly to lift the first lateral body segment comprises:
controlling the first manipulator of the robot to move under a hip on one side of the individual;
controlling the second manipulator of the robot to move to an axillary region on the other side of the individual; and
controlling the first manipulator and the second manipulator to apply upward forces to lift the first lateral body segment of the individual.

10. The method according to claim 3, wherein the third motion sequence includes a lifting operation comprising:
controlling the first manipulator and the second manipulator respectively to be positioned under axillary regions on opposite sides of the individual to lift the individual off the first support structure;
controlling the robot to move, while maintaining support of the individual, to align the individual above the second support structure; and
controlling the manipulator assembly to lower the individual onto the second support structure.

11. The method according to claim 10, further comprising:
controlling the robot to move the second support structure next to the first support structure such that the first support structure and the second support structure form a right angle; and
controlling the robot to perform a stabilization operation on the second support structure to maintain the second support structure in a stable state.

12. The method according to claim 10, further comprising:
controlling the robot to remove obstacles from an area surrounding the second support structure;
controlling front legs of the robot to be positioned on opposite sides of legs of the individual to define an activity range for the legs of the individual; and
controlling the robot to position arms of the individual along a body of the individual in a hanging state, wherein
the hanging state and the activity range increase stability of the individual during the lifting operation.

13. The method according to claim 1, wherein the robot comprises:
the manipulator assembly including the first manipulator and the second manipulator configured to adjust postures of the individual; and
a plurality of mobility components each having a contact element selected from a track, a wheel, or a suction device; and
the plurality of mobility components supporting and stabilizing the robot during execution of the first motion sequence, the second motion sequence, and the third motion sequence.

14. A system, comprising:
processing circuitry configured to:
control a robot to move to an action region of an individual on a first support structure, the action region being a region in which the robot is capable of executing an action to assist the individual;
control, according to a first motion sequence, a manipulator assembly of the robot to adjust the individual from a supine posture on the first support structure to a lateral recumbent posture on the first support structure, the manipulator assembly including a first manipulator and a second manipulator;
control, according to a second motion sequence, the manipulator assembly to adjust the individual from the lateral recumbent posture to an upright seated posture on the first support structure; and
control, according to a third motion sequence, the manipulator assembly to transfer the individual from the upright seated posture on the first support structure to an upright seated posture on a second support structure, wherein
the second support structure is different from the first support structure, and each motion in each of the first motion sequence, the second motion sequence, and the third motion sequence causes a corresponding posture change of the individual.

15. The system according to claim 14, further comprising:
the robot including the manipulator assembly and a plurality of mobility components.

16. The system according to claim 14, wherein the manipulator assembly is configured to perform biomimetic motions, the first support structure is a bed, and the second support structure is a wheelchair.

17. The system according to claim 14, wherein the first motion sequence comprises:
inclining a body portion of the robot toward the individual to position the individual within the action region;
moving the first manipulator of the robot toward a hip region of the individual;
moving the second manipulator toward a shoulder region of the individual; and
controlling the first manipulator and the second manipulator to apply force respectively at the hip region and the shoulder region to adjust the individual from the supine posture to the lateral recumbent posture on the first support structure.

18. The system according to claim 17, wherein the processing circuitry is configured to:
control the first manipulator and the second manipulator, to apply forces that cause one of lateral rotation away from the robot and lateral rotation toward the robot, to turn the individual to the lateral recumbent posture.

19. The system according to claim 17, wherein the processing circuitry is configured to:
control the robot to remove obstacles from an area surrounding the first support structure;
control front legs of the robot to extend under the first support structure to support the robot;
control the robot to position arms of the individual across a chest of the individual; and
control the robot to bend legs of the individual from a straightened state to a bent state, wherein
the bent state, the extended front legs, and the positioning of the arms of the individual increase stability of the individual during adjustment from the supine posture to the lateral recumbent posture.

20. A non-transitory computer-readable storage medium storing instructions which, when executed by a processor, cause the processor to perform:
controlling a robot to move to an action region of an individual on a first support structure, the action region being a region in which the robot is capable of executing an action to assist the individual;
controlling, according to a first motion sequence, a manipulator assembly of the robot to adjust the individual from a supine posture on the first support structure to a lateral recumbent posture on the first support structure, the manipulator assembly including a first manipulator and a second manipulator;
controlling, according to a second motion sequence, the manipulator assembly to adjust the individual from the lateral recumbent posture to an upright seated posture on the first support structure; and
controlling, according to a third motion sequence, the manipulator assembly to transfer the individual from the upright seated posture on the first support structure to an upright seated posture on a second support structure, wherein
the second support structure is different from the first support structure, and each motion in each of the first motion sequence, the second motion sequence, and the third motion sequence causes a corresponding posture change of the individual.
